(19) United States
(12) Patent Application Publication
(10) Pub. No.: US 2017/0009851 A1
(43) Pub. Date: Jan. 12, 2017

(54) SHAFT SUPPORTING DEVICE DETACHABLY MOUNTED TO MOTOR BODY AND MOTOR EQUIPPED WITH SHAFT SUPPORTING DEVICE

(71) Applicant: FANUC CORPORATION, Yamanashi (JP)

(72) Inventor: Yuusuke Fukushima, Yamanashi (JP)

(73) Assignee: FANUC CORPORATION, Yamanashi (JP)

(21) Appl. No.: 15/189,222

(22) Filed: Jun. 22, 2016

(30) Foreign Application Priority Data
Jul. 6, 2015 (JP) 2015-135534

(51) Int. Cl. F16H 7/20; H02K 7/00; H02K 7/08

(52) U.S. Cl. CPC F16H 7/20; H02K 7/08; H02K 7/003

(57) ABSTRACT

A shaft supporting device supports an output shaft of a motor. The shaft supporting device comprises a bearing which supports the output shaft in rotatable manner and a mounting part which fixedly holds the bearing in a position spaced apart from the motor body. One end of the mounting part is fixed to the bearing. The other end of the mounting part has a shape which fits on the motor body, and is removably fixed to the motor body. The mounting part is formed so that a center axis of the bearing coincides with a rotation axis of the output shaft when the other end is fitted on the motor body.

### BACKGROUND OF THE INVENTION

1. Field of the Invention

The present invention relates to a shaft supporting device detachably mounted to a motor body and a motor equipped with such a shaft supporting device.

2. Description of the Related Art

The rotational force generated by a motor is transmitted to another member via a belt or via a speed reducer. When transmitting the rotational force of the motor, there can occur cases in which a radially acting force is exerted on the output shaft of the motor. For example, when transmitting the rotational force by a belt drive, if a large torque is applied, a large load acting in the radial direction is applied to the output shaft. This can result in damage to the output shaft or to the bearing arranged in the motor.

Japanese Unexamined Patent Publication No. 2005-86979 discloses a motor in which an auxiliary bearing is disposed in the vicinity of the bearing on the load side or the bearing on the opposite side. It is disclosed that, in this motor, if the bearing on the load side or the bearing on the opposite side fails, the rotor can be prevented from contacting the stator.

Japanese Unexamined Patent Publication No. 2000-316251 discloses a rotating electrical machine in which an auxiliary bearing is disposed in the vicinity of a main bearing which supports a rotary shaft to which the rotor is clamped. It is disclosed that, in this rotating electrical machine, the auxiliary bearing is supported on an outer frame via a supporter having elasticity.

The output shaft of the motor is supported by the bearing disposed inside the motor body. When a radially acting force is exerted on the output shaft, the forward end of the output shaft protruding outwardly from the motor body can be supported by a bearing fixed to a given machine. This structure serves to prevent the output shaft as well as the bearing arranged in the motor from being damaged. However, if the forward end of the output shaft is to be supported, the bearing which supports the forward end of the output shaft must be centered with respect to the output shaft. In this case, it takes time and labor to install the motor to the machine.

In the motor disclosed in the above-cited Japanese Unexamined Patent Publication, the portion of the output shaft which protrudes outside the motor body is not supported. As a result, if large load acting in the radial direction is applied to the output shaft, the output shaft or the bearing arranged in the motor may be damaged. Furthermore, since an additional bearing has to be provided inside the motor body, the internal structure of the existing motor has to be modified.

### SUMMARY OF INVENTION

A shaft supporting device according to the present invention is a shaft supporting device for supporting an output shaft of a motor which protrudes from a motor body, and comprises a bearing which supports the output shaft in rotatable manner and a mounting part which fixedly holds the bearing in a position spaced apart from the motor body. One end of the mounting part is fixed to the bearing. The other end of the mounting part has a shape which fits on the motor body, and is removably fixed to the motor body. The mounting part is formed so that a center axis of the bearing coincides with a rotation axis of the output shaft when the other end is fitted on the motor body.

In the above invention, the mounting part can include a holding part fixed to the bearing and a supporting part fixed to the holding part and formed in a tubular shape, wherein a pulley around which a belt is engaged can be fixedly attached to the output shaft inside the supporting part, and the supporting part can have an opening through which the belt is passed.

In the above invention, the mounting part can include a holding part fixed to the bearing, and a supporting part fixed to the holding part, wherein the supporting part can be formed in a cylindrical shape.

In the above invention, the mounting portion can include a cutout part which is formed around an inner circumferential surface at the other end and which fits on a convex part of the motor body.

In the above invention, the device can further comprise an extension shaft which is connected to the output shaft coaxially therewith and the extension shaft can be supported by the bearing.

In the above invention, the mounting part can include a holding part fixed to the bearing, a supporting part fixed to the holding part, and an interposing member which is arranged between the supporting part and the motor body, the interposing member can be formed so as to be able to be fixed to a predetermined fixing part of a machine. Furthermore, one end of the interposing member can be fitted into the supporting part and removably fixed to the supporting part. The other end of the interposing member can be fitted on the motor body and removably fixed to the motor body.

A motor according to the present invention comprises the above-described shaft supporting device and the motor body.

### BRIEF DESCRIPTION OF THE DRAWINGS

FIG. 1 is a schematic diagram, partly in cross section, of a motor equipped with a first shaft supporting device according to an embodiment.

FIG. 2 is a perspective view of a supporting part and holding part of the first shaft supporting device according to the embodiment.

FIG. 3 is a schematic diagram, partly in cross section, illustrating how the first shaft supporting device is mounted to a motor body.

FIG. 4 is a schematic side view of a machine on which a motor equipped with a shaft supporting device according to a comparative example is installed.

FIG. 5 is a schematic diagram, partly in cross section, of a second shaft supporting device according to the embodiment.

FIG. 6 is a schematic diagram, partly in cross section, of a third shaft supporting device according to the embodiment.

FIG. 7 is a schematic diagram, partly in cross section, of a machine on which a fourth shaft supporting device according to the embodiment is installed.

FIG. 8 is a perspective view of a supporting part and holding part of the fourth shaft supporting device according to the embodiment.

### DETAILED DESCRIPTION

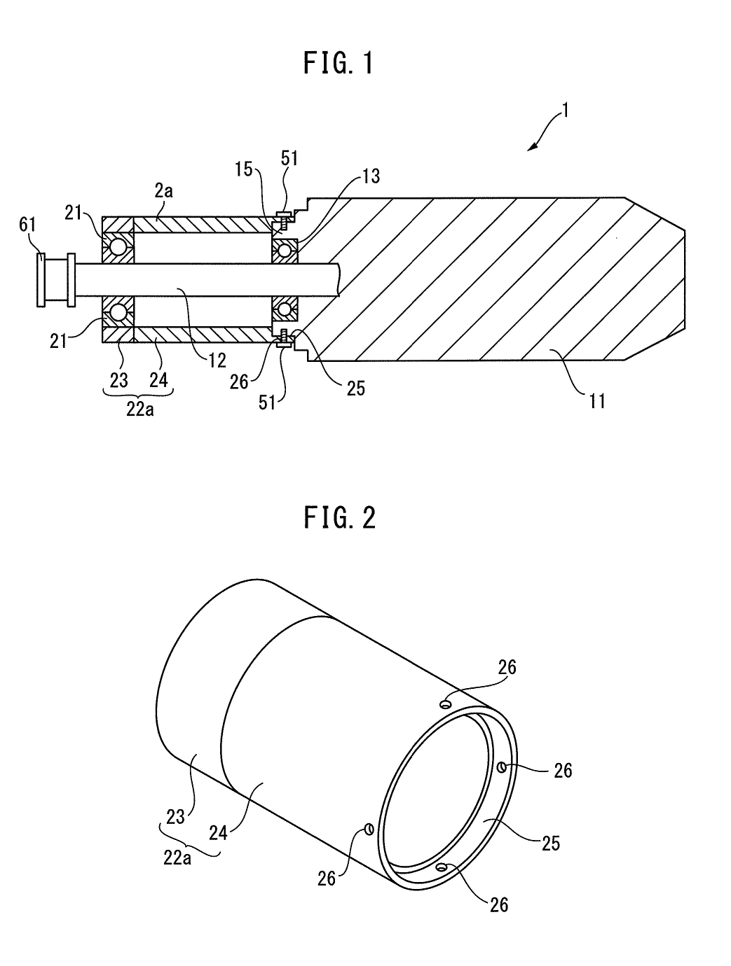

A shaft supporting device according to an embodiment and a motor equipped with the shaft supporting device will be described below with reference to FIGS. 1 to 8. The shaft supporting device according to the present embodiment has the function of supporting the output shaft of the motor. The shaft supporting device is configured so as to be detachably mounted to the motor body.

FIG. 1 shows a schematic diagram, partly in cross section, of a motor equipped with a first shaft supporting device according to the embodiment. The motor 1 comprises a motor body 11 and a shaft supporting device 2a. The shaft supporting device 2a is constructed so that it can be attached to the outside of the motor body 11.

The motor 1 comprises an output shaft 12. The output shaft 12 is supported by a bearing 13 arranged in the motor body 11. The bearing 13 is disposed in an end portion of the motor body 11 from which the output shaft 12 protrudes. In the example shown in FIG. 1, a pulley 61 is fixedly attached to the forward end of the output shaft 12.

The shaft supporting device 2a includes a bearing 21 which supports the output shaft 12 in rotatable manner and a mounting part 22a which fixes the bearing 21 to the motor body 11. The mounting part 22a fixedly holds the bearing 21 in a position spaced apart from the motor body 11. The mounting part 22a includes a holding part 23 and a supporting part 24. The bearing 21 is held fixedly within the holding part 23. In the present embodiment, the bearing 21 is constructed from roller bearings, but alternatively, use may be made of slide bearings.

FIG. 2 shows a perspective view of the supporting part and the holding part according to the present embodiment. Referring to FIGS. 1 and 2, the supporting part 24 is formed in a cylindrical shape. The supporting part 24 has a longitudinal direction and one end is fixed to the holding part 23. That is, one end of the mounting part 22a is fixed to the bearing 21.

The other end of the mounting part 22a has a shape which fits on the motor body 11. That is, the other end of the supporting part 24 is formed so as to fit on the motor body 11. A cutout part 25 is formed around the inner circumferential surface at the other end of the supporting part 24. A convex part 15 is formed at the end of the motor body 11 from which the output shaft 12 protrudes. There is formed a fitting part where the mounting part 22a is fitted onto the motor body 11 by fitting the cutout part 25 onto the convex part 15.

The supporting part 24 is formed so that, when the other end is fitted on the motor body 11, the center axis of the bearing 21 (the rotation axis of the inner race of the bearing 21) coincides with the rotation axis of the output shaft 12. Further, holes 26 through which fastening members for fixedly fastening the mounting part 22a to the motor body 11 are to be passed are formed in a region where the cutout part 25 of the supporting part 24 are formed. In the present embodiment, bolts 51 are used as the fastening members. The supporting part 24 is fixedly secured to the motor body 11 by the bolts 51.

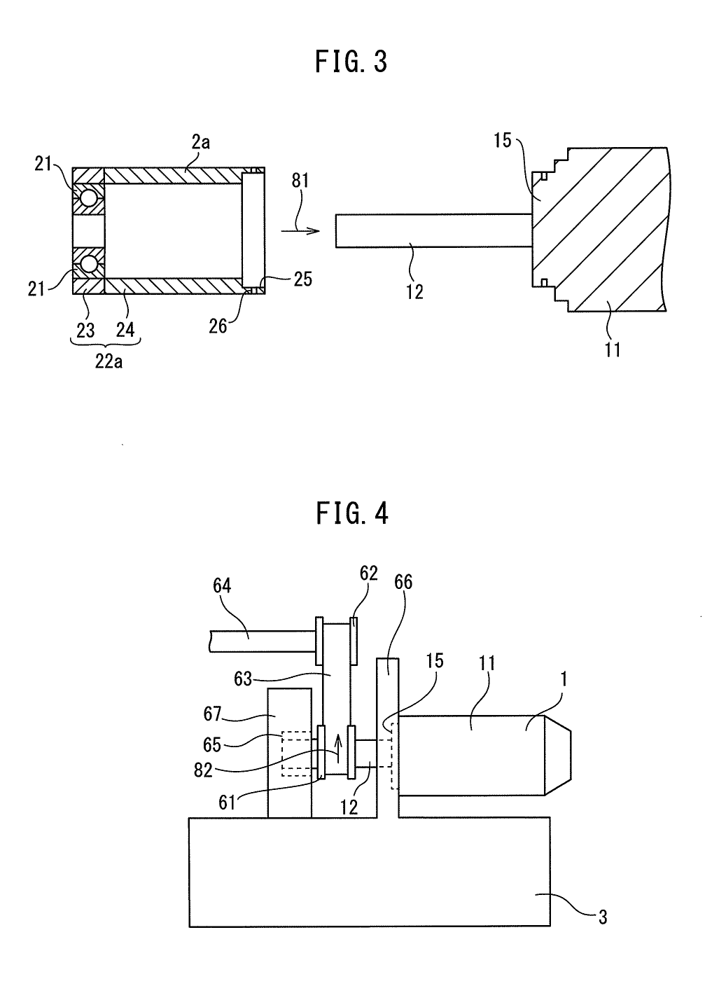

FIG. 3 shows a schematic diagram, partly in cross section, illustrating how the shaft supporting device is mounted to the motor body. The mounting part 22a is mounted to the motor body 11 as indicated by an arrow 81. The cutout part 25 formed in the end portion of the supporting part 24 is shaped so as to correspond to the shape of the convex part 15 of the motor body 11. The center axis of the bearing 21 is aligned with the rotation axis of the output shaft 21 by fitting the cutout part 25 onto the convex part 15. That is, the bearing 21 can be centered by just fitting the cutout part 25 onto the convex part 15. In this way, the bearing 21 and the output shaft 12 can be easily axially aligned with each other in the assembly process of the motor. Then, the shaft supporting device 2a can be fixedly secured to the motor body 11 by the bolts 51, as shown in FIGS. 1 and 3. After that, the pulley 61 can be attached to the output shaft 12. When disassembling, the pulley 61 is removed from the output shaft 12. Then, the shaft supporting device 2a can be easily detached from the motor body 11 by the bolts 51 being removed.

FIG. 4 shows schematic side view when a motor according to a comparative example is installed on a given machine. In the comparative example shown in FIG. 4, a belt drive is employed in order to supply a rotational force to a designated part of the machine 3. In such a belt drive, a radial load which is given by dividing the transmitted torque by the radius of the pulley is applied to the output shaft 12. In the case of a machine which requires a large torque, since a large radial load is applied to the output shaft 12, the output shaft 12 or the bearing arranged in the motor body 11 is liable to be damaged.

The machine 3 includes a fixing part 66 for fixedly holding the motor body 11. The position of the rotation axis of the output shaft 12 is determined by fitting the convex part 15 formed at the end of the motor body 11 into a concave part formed in the fixing part 66. The machine 3 comprises a bearing 65 for supporting the forward end of the output shaft 12. The bearing 65 is fixedly held in a fixing part 67 formed on the machine 3. The pulley 61 is fixed to the output shaft 12.

The machine 3 includes a rotary shaft 64 to which a pulley 62 is attached. A belt 63 is engaged with the pulley 61 and the pulley 62. When the motor 1 is driven, the belt 63 moves in the direction of arrow 82. The rotational force of the output shaft 12 is thus transmitted to the rotary shaft 64.

In the motor 1 of the comparative example, since the forward end of the output shaft 12 is supported by the bearing 65, the radially acting force being exerted on the output shaft 12 can be supported at two portions. This serves to prevent the output shaft 12, etc. from being damaged. However, when installing the motor 1, the output shaft 12 must be centered with respect to the bearing 65. That is, the position of the bearing 65 must be adjusted so that the center axis of the bearing 65 coincides with the rotation axis of the output shaft 12. This leads to the problem that it takes time and labor to install the motor 1 to the machine 3.

In contrast, in the motor 1 according to the present embodiment described with reference to FIGS. 1 to 3, upon fitting the supporting part 24 onto the motor body 11, the center axis of the bearing 21 of the shaft supporting device 2a is aligned with the rotation axis of the output shaft 12. This eliminates the task of axially aligning the bearing 21. Next, the pulley 61 can be attached to the output shaft 12. Then, the motor body 11 can be fixed to a designated part of the machine.

In the motor 1 according to the present embodiment, the bearing 21 is located away from the bearing 13 due to the provision of the shaft supporting device 2a. The bearing 21 is supported on the motor body 11. In this way, the output shaft 12 can be supported at two portions, so that the output shaft 12 as well as the bearing 13 disposed inside the motor body 11 can be prevented from being damaged.

Further, the shaft supporting device 2a according to the present embodiment is constructed so that it can be attached from outside the motor body 11. Therefore, the motor body 11 need only be constructed so that the shaft supporting device 2a can be attached to it, and there is no need to modify the internal structure of the motor body 11. For example, by just modifying the structure of the casing of the motor body 11, the shaft supporting device according to the present embodiment can be attached to it. Furthermore, if the shaft supporting device 2a is failed, the shaft supporting device 2a need only be detached and replaced with a new one. In this way, the machine can be restarted in a short time.

The supporting part 24 of the mounting part 22a according to the present embodiment is formed in a cylindrical shape. By employing this configuration, the structure of the mounting part can be simplified while increasing its strength.

While the above embodiment has illustrated a belt-drive type machine which drives a given rotary shaft by using a belt, the embodiment is not limited to this particular type, but the shaft supporting device of the present embodiment is advantageous for any type of machine whose output shaft is subjected to a radial load. For example, a gear may be mounted on the output shaft of the motor. In this case also, the output shaft of the motor may be subjected to a load in the radial direction of the output shaft due to reaction force from the gear. It is advantageous to attach the shaft supporting device of the present embodiment to such a motor.

Any desired configuration can be employed for the fitting part where the mounting part of the shaft supporting device is fitted on the motor body. Likewise, any desired configuration can be employed for the fixing part for fixing the shaft supporting device to the motor body.

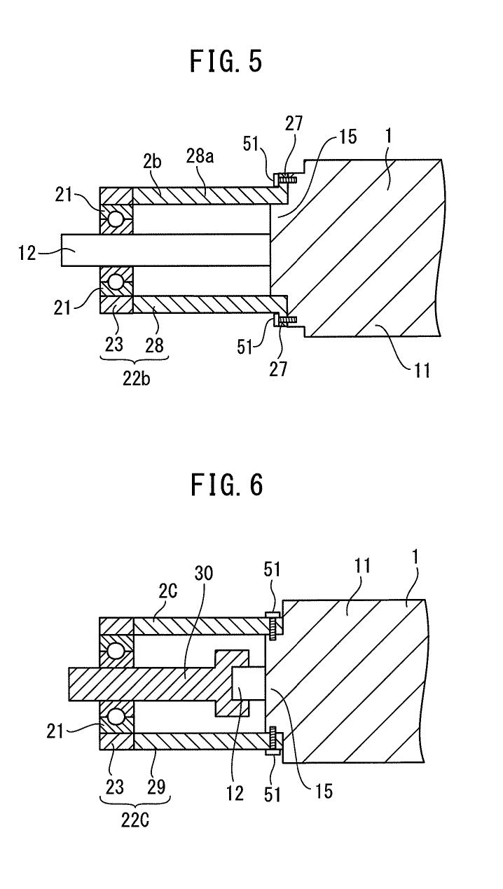

FIG. 5 shows a schematic diagram, partly in cross section, of a motor equipped with a second shaft supporting device according to the present embodiment. The second shaft supporting device 2b includes a mounting part 22b having a holding part 23 and a supporting part 28. The supporting part 28 includes a tubular part 28a formed in a tubular shape and a flange part 27 formed around the edge of the tubular part 28a. One end of the supporting part 28 is fixed to the holding part 23. The flange part 27 is formed so as to protrude outwardly from the edge at the other end of the tubular part 28a.

The inner circumferential surface at the other end of the supporting part 28 is not formed with any cutout part. A fitting part is formed by fitting the tubular part 28a onto the convex part 15 of the motor body 11. The shaft supporting device 2b is fixed to the motor body 11 by fixedly fastening the flange part 27 formed at the other end of the mounting part 22b to the motor body 11 by means of screws 51. As illustrated with respect to the second shaft supporting device 2b, the flange part 27 may be formed on the mounting part 22b, and the flange part 27 may be fixed to the motor body 11 by the screws 51.

FIG. 6 shows a schematic diagram, partly in cross section, of a motor equipped with a third shaft supporting device according to the present embodiment. The third shaft supporting device 2c includes a mounting part 22c. The mounting part 22c includes a holding part 23 and a supporting part 29. One end of the supporting part 29 is fixed to the holding part 23. The supporting part 29 is formed in a tubular shape. The other end of the supporting part 29 is not formed with any cutout part. A fitting part is formed by fitting the inner surface of the supporting part 29 onto the convex part 15 of the motor body 11. The other end of the mounting part 22c is fixed to the motor body 11 by inserting the bolts 51 in the radial direction.

The third shaft supporting device 2c further comprises an extension shaft 30 connected to the output shaft 12. The extension shaft 30 is formed in the shape of a column. The extension shaft 30 is connected to the output shaft 12 so as to be coaxial with the output shaft 12. More specifically, the extension shaft 30 is fixed to the output shaft 12 so that the rotation axis of the extension shaft 30 coincides with the rotation axis of the output shaft 12. The extension shaft 30 is passed through the bearing 21. The extension shaft 30 is supported by the bearing 21. Since the shaft supporting device 2c is provided with the extension shaft 30, the shaft supporting device 2c of the present embodiment can be attached to the motor 1 even when the output shaft 12 is short.

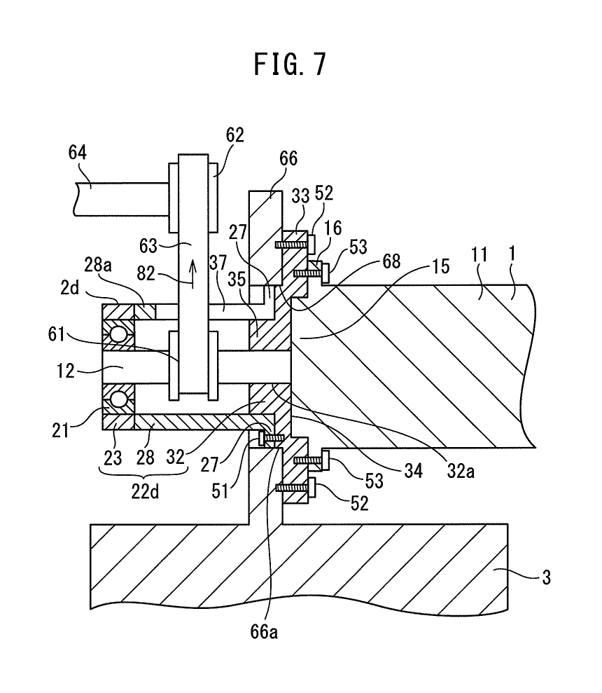

FIG. 7 shows a schematic diagram, partly in cross section, of a motor equipped with a fourth shaft supporting device according to the present embodiment. The motor 1 shown in FIG. 7 is installed on a predetermined machine 3. The machine 3 may be any suitable machine such as a press machine or a molding machine. The motor 1 here is equipped with the fourth shaft supporting device 2d.

The machine 3 rotates a member connected to a rotary shaft 64 by means of a belt drive. The motor 1 drives the rotary shaft 64 via a belt 63. A pulley 62 is fixed to the rotary shaft 64. A pulley 61 is fixedly attached to the output shaft 12 of the motor 1. The belt 63 is engaged with the pulley 61 and the pulley 62. When the motor 1 is driven, the pulley 61 rotates. The belt 63 then moves in the direction of arrow 82 to rotate the pulley 62 thereby causing the rotary shaft 64 to rotate.

The shaft supporting device 2d comprises a mounting part 22d for fixing the bearing 21 to the motor body 11. The mounting part 22d includes a holding part 23, a supporting part 28 fixed to the holding part 23, and an interposing member 32 which is arranged between the supporting part 28 and the motor body 11.

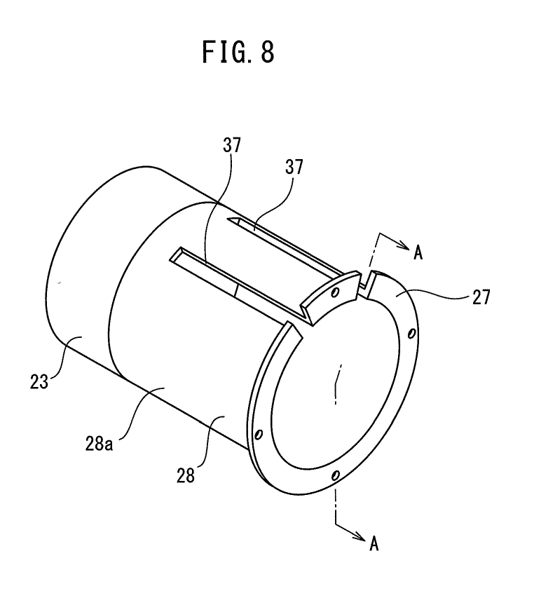

FIG. 8 shows a perspective view of the supporting part and holding part of the fourth shaft supporting device. FIG. 7 is a partially cross-sectional view taken along line A-A in FIG. 8. Referring to FIGS. 7 and 8, the supporting part 28 includes a tubular part 28a and a flange part 27. One end of the interposing member 32 has a shape which fits to the other end of the supporting part 28. A convex part 35 is formed at the one end of the interposing member 32. The convex part 35 is formed so as to fit into the tubular part 28a. In the present embodiment, since the tubular part 28a is formed in a cylindrical shape, the convex part 35 is formed in the shape of a column.

The flange part 27 is formed at the other end of the supporting part 28. The flange part 27 is fixedly fastened to the interposing member 32 by means of bolts 51. The supporting part 28 is removably fixed to the interposing member 32.

The supporting part 28 has an opening 37 through which the belt 63 is passed. In the present embodiment, the opening 37 is formed so as to extend linearly toward one end of the supporting part 28 from the other end thereof. A plurality of such openings 37 are formed. Since the openings 37 through which to pass the belt 63 are formed in the supporting part 28, the pulley 61 can be placed inside the supporting part 28. The openings through which to pass the belt are not limited to this particular configuration, but any configurations which can pass the belt therethrough can be employed.

The machine 3 includes a fixing part 66 for fixing the motor 1. The interposing member 32 is fitted into an opening 66a formed in the fixing part 66. The interposing member 32 includes a flange part 33 extending outwardly. The interposing member 32 is fixed to the fixing part 66 by fastening the flange part 33 to the fixing part 66 by means of bolts 52.

The interposing member 32 has a hole 32a through which the output shaft 12 is passed. The interposing member 32 includes a concave part 34 formed at the other end at which the motor body 11 is disposed. The convex part 15 of the motor body 11 is formed in the columnar shape. The concave part 34 is shaped to match the shape of the convex part 15 of the motor body 11. There is formed a fitting part where the shaft supporting device 2d is fitted onto the motor body 11 by fitting the concave part 34 onto the convex part 15 of the motor body 11.

The motor body 11 includes a flange part 16 extending outwardly. The motor body 11 is fixed to the interposing member 32 by fixedly fastening the flange part 16 to the interposing member 32 by means of bolts 53. In this way, the motor body 11 is removably fixed to the other end of the interposing member 32.

In the motor 1, there are certain cases in which the convex part 15 is formed in such a manner as to facilitate the adjustment of the mounting position when mounting the motor body 11 to the machine 3. In such cases, once the supporting part 28 is fitted onto the convex part 15, the motor body 11 may become unable to be mounted to the fixing part 66. In the case of the fourth shaft supporting device 2d, on the other hand, since the mounting part 22d is provided with the interposing member 32, the motor body 11 can be fixed to the fixing part 66 after fixedly attaching the shaft supporting device 2d.

Further, the bearing 21 and the supporting part 28 can be removed by removing the bolts 51 while leaving the motor body 11 fixed to the interposing member 32. Alternatively, the motor body 11 can be removed by removing the bolts 53 while leaving the interposing member 32 fixed to the fixing part 66. As a result, when a component such as the motor body 11 or the bearing 21 fails, the failed component can be easily removed. For example, when the bearing 21 fails, the supporting part 28 can be removed while leaving the motor body 11 fixed to the fixing part 66. Then, the bearing 21 can be replaced with a new one.

Furthermore, the convex part 15 of the motor body 11 is formed so that the rotation axis of the output shaft 12 coincides with the center axis of the convex part 35 of the interposing member 32 when the convex part 15 is fitted into the concave part 34 of the interposing member 32. The convex part 35 of the interposing member 32 is formed so that the center axis of the convex part 35 coincides with the center axis of the bearing 21 when the tubular part 28a of the supporting part 28 is fitted onto the convex part 35. By adopting this configuration, the bearing 21 can be axially aligned with respect to the output shaft 12 by just fitting and fixing the supporting part 28 and motor body 11 to the interposing member 32. That is, the output shaft 12 can be easily centered with respect to the bearing 21.

While, in the above embodiment, the supporting part of the mounting part has been described as being formed in a cylindrical shape, the cross-sectional shape of the supporting part need not be limited to any particular shape but any suitable shape may be employed. For example, the supporting part may include a tubular part whose cross-sectional shape is quadrilateral. Further, in the above embodiment, the supporting part is formed in a cylindrical shape, but the shape is not limited to this particular one, the only requirement being that the supporting part be formed so that the holding part for holding the bearing can be fixed in a position spaced apart from the motor body. For example, the supporting part may be constructed from a plurality of rod members.

According to the present invention, it becomes possible to provide a shaft supporting device which is attachable to and detachable from the motor body and which is configured to prevent the output shaft as well as the bearing arranged in the motor body from being damaged, and also provide a motor which is equipped with such a shaft supporting device.

The above embodiments may be suitably combined. Throughout the above drawings, the same or corresponding parts are designed by the same reference numerals. The above embodiments are only illustrative and not restrictive of the invention. Further, the embodiments include alterations which could be made to the embodiments described in the appended claims.

1. A shaft supporting device for supporting an output shaft of a motor which protrudes from a motor body, comprising:
a bearing which supports the output shaft in rotatable manner; and
a mounting part which fixedly holds the bearing in a position spaced apart from the motor body; wherein
one end of the mounting part is fixed to the bearing,
the other end of the mounting part has a shape which fits on the motor body and is removably fixed to the motor body, and
the mounting part is formed so that a center axis of the bearing coincides with a rotation axis of the output shaft when the other end is fitted on the motor body.

2. The shaft supporting device according to claim 1, wherein
the mounting part includes a holding part fixed to the bearing, and a supporting part fixed to the holding part and formed in a tubular shape,
a pulley around which a belt is engaged is fixedly attached to the output shaft inside the supporting part, and
the supporting part has an opening through which the belt is passed.

3. The shaft supporting device according to claim 1, wherein
the mounting part includes a holding part fixed to the bearing, and a supporting part fixed to the holding part, and
the supporting part is formed in a cylindrical shape.

4. The shaft supporting device according to claim 1, wherein
the mounting portion includes a cutout part which is formed around an inner circumferential surface at the other end and which fits on a convex part of the motor body.

5. The shaft supporting device according to claim 1, further comprising an extension shaft which is connected to the output shaft coaxially therewith, wherein
the extension shaft is supported by the bearing.

6. The shaft supporting device according to claim 1, wherein
the mounting part includes a holding part fixed to the bearing, a supporting part fixed to the holding part, and an interposing member which is arranged between the supporting part and the motor body,
the interposing member is formed so as to be able to be fixed to a predetermined fixing part of a machine,
one end of the interposing member is fitted into the supporting part and removably fixed to the supporting part, and
the other end of the interposing member is fitted on the motor body and removably fixed to the motor body.

7. A motor comprising the shaft supporting device according to claim 1 and the motor body.
